(19) United States
(12) Patent Application Publication
(10) Pub. No.: US 2016/0294125 A1
(43) Pub. Date: Oct. 6, 2016

(54) SPARKLESS SOCKET

(71) Applicant: ELIFECONNECTION CO., LTD., Taipei City (TW)

(72) Inventor: Cheng-Tsuen Hsu, Taipei City (TW)

(21) Appl. No.: 14/753,013

(22) Filed: Jun. 29, 2015

(30) Foreign Application Priority Data
Apr. 1, 2015 (TW) 104110702

(51) Int. Cl. H01R 13/703; H01R 13/66

(52) U.S. Cl. CPC H01R 13/7036; H01R 13/6683

(57) ABSTRACT

A sparkless socket is provided. The sparkless socket includes a socket, a sensing module, a controller, and a switching module. The sensing module includes an emitter and a receiver. The emitter emits infrared light. The receiver receives the infrared light form the emitter through a light guide element module and through holes on slots of the socket and generates a sensing result accordingly. The controller is coupled to the sensing module to receive the sensing result. The controller is coupled to a city power system. The switching module is coupled between the socket and the controller to receive AC power provided by the city power system from the controller and is controlled by the controller to transmit the AC power to the socket. The controller determines whether a plug is plugged into the socket according to the sensing result and thereby enables or disables the switching module.

### CROSS-REFERENCE TO RELATED APPLICATION

This application claims the priority benefit of Taiwan application serial no. 104110702, filed on Apr. 1, 2015. The entirety of the above-mentioned patent application is hereby incorporated by reference herein and made a part of this specification.

### BACKGROUND OF THE INVENTION

1. Field of the Invention

The invention relates to a socket, in particular, to a sparkless socket means. Such sparkless socket means would prevent sparks generated at the moment of plugging or unplugging a plug.

2. Description of Related Art

A conventional socket means is illustrated as FIG. 1 and FIG. 2. Such socket means includes a housing 1. Two parallel slots 2 and at least one base unit 3 are configured on the housing 1. Two limiting slots 4 are configured on the base unit 3, where a first clip 5a and a second clip 5b made of conductive material and opposite to each other are configured on each of the limiting slots 4. For simplicity, only one of the slots 2 and its corresponding limiting slots 4 will be described herein. The middle part of each of the first clip 5a and the second clip 5b is bent inward so that the distance between the first clip 5a and the second clip 5b decreases and a clamped portion 5c is formed thereby. The first clip 5a and the second clip 5b are farther toward one end of the slot 2 and connected to each other to form an electrical terminal 6. The electrical terminal 6 is configured to connect to city power. The ends of the first clip 5a and the second clip 5b, which are closer to the slot 2, form an open insertion port 7, where the insertion port 7 corresponds to the slot 2.

Accordingly, the user may plug the plug 8 into the socket means so that electricity would be provided to an appliance connected to the plug 8. When the plug 8 is plugged into the insertion port 7 through the two slots 2 via two parallel and plate-like pins 9 and resisted by a front wall of the base unit 3, each of the pins 9 would be clamped by the clamp portion 5c of the first clip 5a and the second clip 5b so that the electricity of the city power would be conducted from the first clip 5a and the second clip 5b to the two pins 9 of the plug 8 and lead to a conducting state.

However, when the user inserts the two pins 9 of the plug 8 into the slots 2 or removes the two pins 9 of the plug 8 from the insertion slot 7, sparks could be easily generated at the moment when the two pins 9 of the plug 8 are contacted with or pulled out from the first clip 5a and the second clip 5b, where the generated sparks would not only cause danger but would also scare the user.

### SUMMARY OF THE INVENTION

Accordingly, the invention is directed to a sparkless socket which would prevent sparks that are generated and cause danger at the moment when a plug contacts or is pulled out from conductive plates in a socket so as to reduce user's fear and enhance the electricity safety.

A sparkless socket provided in the invention is adapted to provide a configuration to a pair of pins of a plug. The sparkless socket includes a socket, a sensing module, a controller, and a switching module. A first slot and a second slot are configured in the socket. A through hole is configured on a slot wall of each of the first slot and the second slot, where the through holes pass through each other. The sensing module includes an emitter and a first receiver. The emitter is configured to emit infrared light. The first receiver is configured to receive the infrared light via a light guide element module and at least one of the through holes and accordingly generate a first sensing result. The controller is coupled to the sensing module and configured to receive the first sensing result. The controller is also connected to a city power system. The switching module is coupled between the socket and the controller to receive alternating-current (AC) power provided by the city power system from the controller. The switching module is controlled by the controller to transmit the AC power to the socket. When the controller determines that the first receiver does not receive the infrared light based on the first sensing result, the controller enables the switching module; otherwise, the controller disables the switching module.

According to an embodiment of the invention, the sensing module further includes a second receiver. The second receiver is configured to receive the infrared light via the light guide element module and one of the through holes and accordingly generate a second sensing result. The first receiver is configured to receive the infrared light via the light guide element module and another one of the through holes and accordingly generate the first sensing result. When the controller determines that none of the first receiver and the second receiver receives the infrared light according to the first sensing result and the second sensing result, the controller enables the switching module; otherwise, the controller disables the switching module.

According to an embodiment of the invention, the emitter is disposed between the first receiver and the second receiver. The light guide element module includes a first light guide pillar, a second light guide pillar, and a third light guide pillar. The first light guide pillar is disposed among the first slot, the second slot, and the emitter, and configured to guide the infrared light emitted by the emitter. An entrance of the first light guide pillar is facing to the emitter to receive the infrared light emitted by the emitter. An exit of the first light guide pillar is facing to the through hole of the first slot, and another exit of the first light guide pillar is facing to the through hole of the second slot. The second light guide pillar is disposed between the first slot and the first receiver. An entrance of the second light guide pillar is facing to the through hole of the first slot, and an exit of the second light guide pillar is facing to the first receiver. The third light guide pillar is disposed between the second slot and the second receiver. An entrance of the third light guide pillar is facing to the through hole of the second slot, and an exit of the third light guide pillar is facing to the second receiver.

According to an embodiment of the invention, when the pair of pins of the plug is not inserted or not completely inserted into the first slot and the second slot, the infrared light emitted by the emitter is transmitted to the first receiver via the first light guide pillar, the through hole of the first slot, and the second light guide pillar sequentially, and the infrared light emitted by the emitter is transmitted to the second receiver via the first light guide pillar, the through hole of the second slot, and the third light guide pillar sequentially. On the other hand, after the pair of pins of the plug is completely inserted into the first slot and the second slot, the pair of pins of the plug covers the through hole of the first slot and the through hole of the second slot to block the infrared light guided by the first light guide pillar.

According to an embodiment of the invention, the light guide element module includes a first light guide pillar and a second light guide pillar. The first light guide pillar is disposed between the first slot and the emitter, and configured to guide the infrared light emitted by the emitter. An entrance of the first light guide pillar is facing to the emitter to receive the infrared light emitted by the emitter, and an exit of the first light guide pillar is facing to the through hole of the first slot. The second light guide pillar is disposed between the second slot and the first receiver. An entrance of the second light guide pillar is facing to the through hole of the second slot, and an exit of the second light guide pillar is facing to the first receiver. The first slot and the second slot are disposed between the first light guide pillar and the second light guide pillar.

According to an embodiment of the invention, when the pair of pins of the plug is not inserted or not completely inserted into the first slot and the second slot, the infrared light emitted by the emitter is transmitted to the first receiver via the first light guide pillar, the through hole of the first slot, the through hole of the second slot, and the second light guide pillar sequentially. On the other hand, after the pair of pins of the plug is completely inserted into the first slot and the second slot, the pair of pins of the plug covers the through hole of the first slot and the through hole of the second slot to block the infrared light guided by the first light guide pillar.

A sparkless socket provided in the invention is adapted to provide a configuration to three pins of a plug. The sparkless socket includes a socket, a sensing module, a controller, and a switching module. The socket includes a first slot, a second slot, and a third slot at a different direction from the first slot and the second slot. A through hole is configured on a slot wall of each of the first slot, the second slot, and the third slot. The sensing module includes an emitter, a first receiver, a second receiver, and a third receiver. The emitter is configured to emit infrared light. The first receiver is configured to receive the infrared light via a light guide element module and the through hole of the first slot and accordingly generate a first sensing result. The second receiver is configured to receive the infrared light via the light guide element module and the through hole of the second slot and accordingly generate a second sensing result. The third receiver is configured to receive the infrared light via the light guide element module and the through hole of the third slot and accordingly generate a third sensing result. The controller is coupled to the sensing module and configured to receive the first sensing result, the second sensing result, and the third sensing result. The controller is also connected to a city power system. The switching module is coupled between the socket and the controller to receive AC power provided by the city power system from the controller. The switching module is controlled by the controller to transmit the AC power to the socket. When the controller determines that none of the first receiver, the second receiver, and the third receiver receives the infrared light based on the first sensing result, the second sensing result, and the third sensing result, the controller enables the switching module; otherwise, the controller disables the switching module.

According to an embodiment of the invention, the light guide element module includes a first light guide pillar, a second light guide pillar, a third light guide pillar, and a fourth light guide pillar. The first light guide pillar is disposed among the first slot, the second slot, the third slot, and the emitter, and configured to guide the infrared light emitted by the emitter. An entrance of the first light guide pillar is facing to the emitter to receive the infrared light emitted by the emitter, and three exits of the first light guide pillar are respectively facing to the through hole of the first slot, the through hole of the second slot, and the through hole of the third slot. The second light guide pillar is disposed between the first slot and the first receiver. An entrance of the second light guide pillar is facing to the through hole of the first slot, and an exit of the second light guide pillar is facing to the first receiver. The third light guide pillar is disposed between the second slot and the second receiver. An entrance of the third light guide pillar is facing to the through hole of the second slot, and an exit of the third light guide pillar is facing to the second receiver. The fourth light guide pillar is disposed between the third slot and the third receiver. An entrance of the fourth light guide pillar is facing to the through hole of the third slot, and an exit of the fourth light guide pillar is facing to the third receiver.

According to an embodiment of the invention, the first light guide pillar includes a first pin, a second pin, a third pin, and a fourth pin, where the first pin, the second pin, the third pin, and the fourth pin form a three-dimensional double T-shaped structure. The first pin, the second pin, and the third pin are connected to each other and form a T-shaped structure; the first pin, the second pin, and the fourth pin are connected to each other and form a T-shaped structure; the third pin and the fourth pin are connected and form an inverted-L structure. The entrance of the first light guide pillar is disposed at the fourth pin, and the three exits of the first light guide pillar are respectively disposed at the first pin, the second pin, and the third pin.

According to an embodiment of the invention, when the three pins of the plug are not inserted or not completely inserted into the first slot, the second slot, and the third slot: the infrared light emitted by the emitter is transmitted to the first receiver via the first light guide pillar, the through hole of the first slot, and the second light guide pillar sequentially; the infrared light emitted by the emitter is transmitted to the second receiver via the first light guide pillar, the through hole of the second slot, and the third light guide pillar sequentially; the infrared light emitted by the emitter is transmitted to the third receiver via the first light guide pillar, the through hole of the third slot, and the fourth light guide pillar sequentially. On the other hand, after the three pins of the plug are completely inserted into the first slot, the second slot, and the third slot, the three pins of the plug cover the through hole of the first slot, the through hole of the second slot, and the through hole of the third slot to block the infrared light guided by the first light guide pillar.

In view of the foregoing, the sparkless socket provided in the invention allows the controller to disable the switching module based on infrared light emitted by the emitter and received by the receiver via the through holes before a plug of an appliance is completely plugged into the socket. On the other hand, after the plug of the appliance is completed plugged into the socket, the through holes would be covered by the plug so that the infrared light emitted by the emitter would be blocked and would not be transmitted to the receiver. Meanwhile, the controller, which has not received any infrared sensing signal, would switch the switching module to be enabled so as to provide AC power to the socket. Thus, sparks would be prevented from being generated at the moment when pins of a plug are contacted with or pulled out from the socket so as to enhance the electricity safety.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a three-dimensional schematic diagram of a conventional socket means.

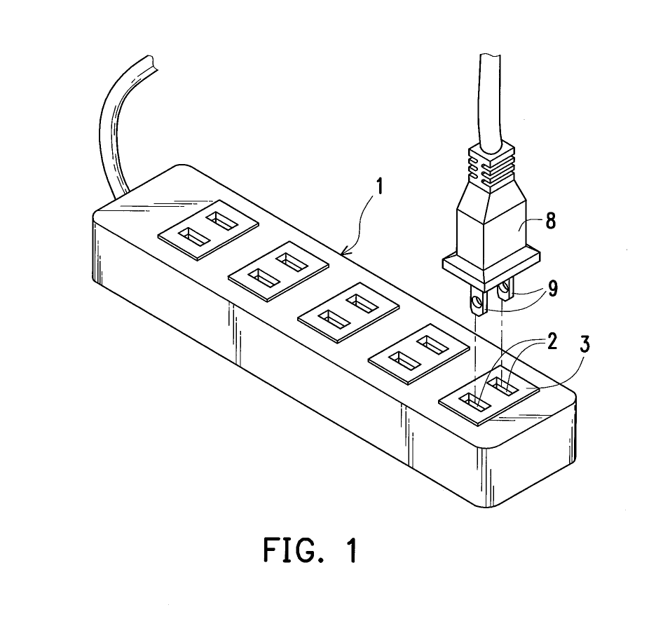

FIG. 2 illustrates a two-dimensional schematic diagram of a conventional socket means.

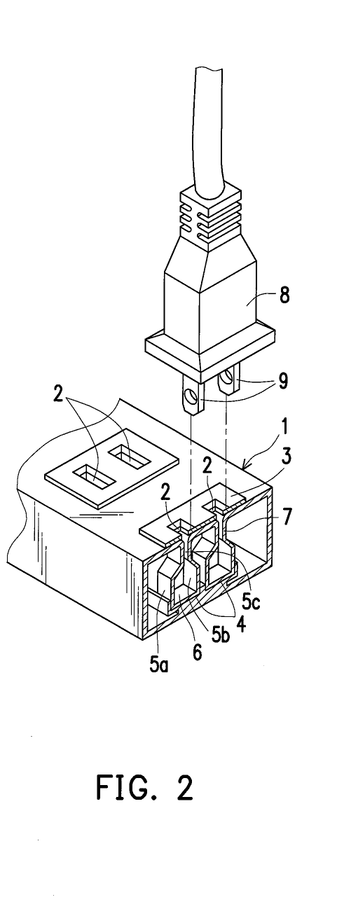

FIG. 3 illustrates a cross-sectional schematic diagram of a sparkless socket along with a plug according to the first embodiment of the invention.

FIG. 4 illustrates a three-dimensional schematic diagram of a first slot of a sparkless socket according to the first embodiment of the invention.

FIG. 5 illustrates a circuit schematic diagram of a sparkless socket according to the first embodiment of the invention.

FIG. 6 illustrates a cross-sectional schematic diagram of a sparkless socket along with a plug according to the first embodiment of the invention.

FIG. 7 illustrates a cross-sectional schematic diagram of a sparkless socket along with a plug according to the second embodiment of the invention.

FIG. 8 illustrates a circuit schematic diagram of a sparkless socket according to the second embodiment of the invention.

FIG. 9 illustrates a cross-sectional schematic diagram of a sparkless socket along with a plug according to the second embodiment of the invention.

FIG. 10 illustrates a top-view schematic diagram of a sparkless socket according to the third embodiment of the invention.

FIG. 11 illustrates a circuit schematic diagram of a sparkless socket according to the third embodiment of the invention.

FIG. 12 illustrates a top-view schematic diagram of a sparkless socket according to the third embodiment of the invention.

FIG. 13 illustrates a three-dimensional structural schematic diagram of a first light guide pillar of a sparkless socket according to the third embodiment of the invention.

FIG. 14 illustrates a circuit block schematic diagram of a switching module in FIG. 5, FIG. 8, and FIG. 11.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

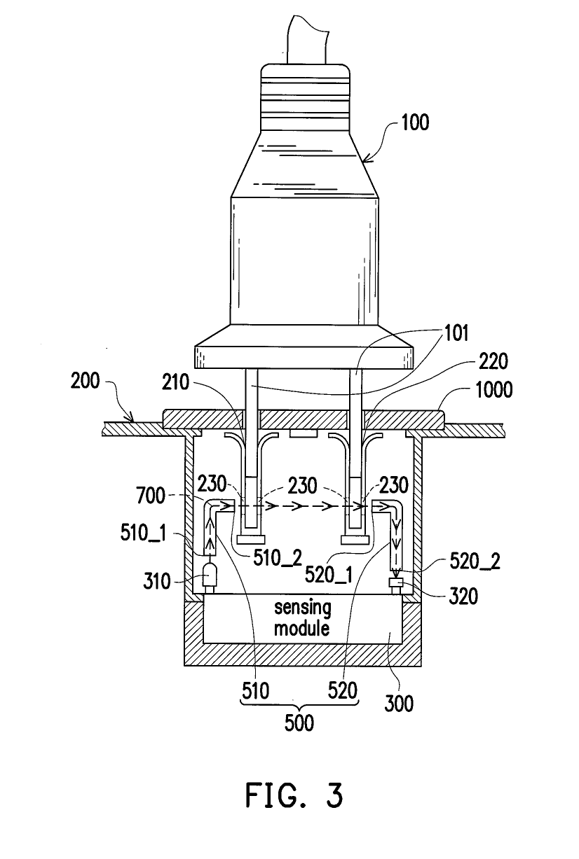

FIGS. 3-5 illustrate a sparkless socket 1000 according to the first embodiment of the invention. Referring to FIGS. 3-5 hereafter, the sparkless socket 1000 may provide a configuration to a pair of pins 101 of a plug 100. The sparkless socket 1000 includes a socket 200, a sensing module 300, a controller 400, and a light guide element module 500. The socket 200 includes a first slot 210 and a second slot 220. A through hole 230 is configured on a slot wall of each of the first slot 210 and the second slot 220, where the through holes 230 are able to pass through each other.

An emitter 310 and a first receiver 320 are configured on the sensing module 300. The emitter 310 is configured to emit infrared light 700 and transmit the infrared light 700 to the first receiver 320 through the light guide element module 500 via the through holes 230. In the present embodiment, the light guide element module 500 includes a first light guide pillar 510 and a second light guide pillar 520. The first light guide pillar 510 is disposed between the first slot 210 and the emitter 310 and configured to guide the infrared light 700 emitted by the emitter 310. An entrance port 510_1 of the first light guide pillar 510 is facing to the emitter 310 so as to receive the infrared light 700 emitted thereby, and an exit port 510_2 of the first light guide pillar 510 is facing to the through hole 230 of the first slot 210. The second light guide pillar 520 is disposed between the second slot 220 and the first receiver 320. An entrance port 520_1 of the second light guide pillar 520 is facing to the through hole 230 of the second slot 220, and an exit port 520_2 of the second light guide pillar 520 is facing to the first receiver 320. The first slot 210 and the second slot 220 are disposed between the first light guide pillar 510 and the second light guide pillar 520. Therefore, the infrared light 700 emitted by the emitter 310 may be transmitted to the first receiver 320 via the first light guide pillar 510, the through hole 230 of the first slot 210, the through hole 230 of the second slot 220, and the second light guide pillar 520. The first receiver 320 may generate a sensing result SR based on whether the infrared light 700 is received.

The controller 400, coupled to a city power system 800 and the sensing module 300, is configured to receive the sensing result SR. A switching module 600, coupled between the socket 200 and the controller 400, receives AC power VAC from the city power system 800 and is controlled by the controller 400 to transmit the AC power VAC to the socket 200. The controller 400 would enable or disable the switching module 600 based on the sensing result SR.

Accordingly, referring to FIG. 3, when the pins 101 of the plug 100 are not inserted or are not completely inserted into the first slot 210 and the second slot 220 of the socket 200, the infrared light 700 emitted by the emitter 310 would be transmitted to the first receiver 320 via the first light guide pillar 510, the through hole 230 on the slot wall of the first slot 210, the through hole 230 on the sidewall of the second slot 220, and the second light guide pillar 520 sequentially. When the first receiver 320 senses the infrared light 700, the sensing module 300 would transmit the sensing result SR to the controller 400. Meanwhile, the controller 400 may control the switching module 600 to be disabled so that the AC power VAC of the city power system 800 would not be able to be provided to the socket 200 through the switching module 600.

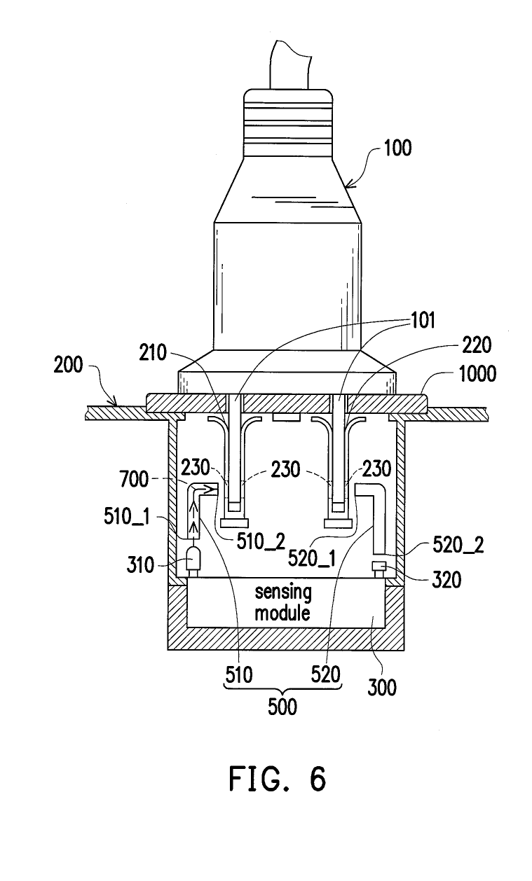

Referring to FIG. 6, after the pins 101 of the plug 100 are completely inserted into the first slot 210 and the second slot 220 of the socket 200, the pins 101 of the plug 100 would cover the through hole 230 on the slot wall of the first slot 210 and thereby block the infrared light 700 guided by the first light guide pillar 510. Hence, the infrared light 700 would not be able to arrive at the first receiver 320. Meanwhile, the first receiver 320 may transmit the sensing result SR of “unable to sense the infrared light 700” to the controller 400. The controller 400 may then switch the switching module 600 to be enabled so that the AC power VAC from the city power system 800 would be able to be transmitted to the socket 200 through the switching module 600 and thereby provide load power to the plug 100. By contrast, during power supply operation, once the plug 100 is not completely plugged into the first slot 210 and the second slot 220 of the socket 200 due to looseness, or once the pins 101 of the plug 100 are to be pulled out from the first slot 210 and the second slot 220 of the socket 200, the first receiver 320 would sense the infrared light 700, and the controller 400 would switch the switching module 600 to be disabled immediately (e.g. within 0.015 s or within 15 ms). Thus, sparks which cause dangers would be prevented from being generated between the pins 101 and each of the first slot 210 and the second slot 220.

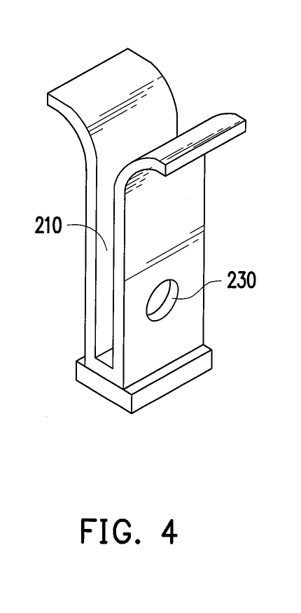

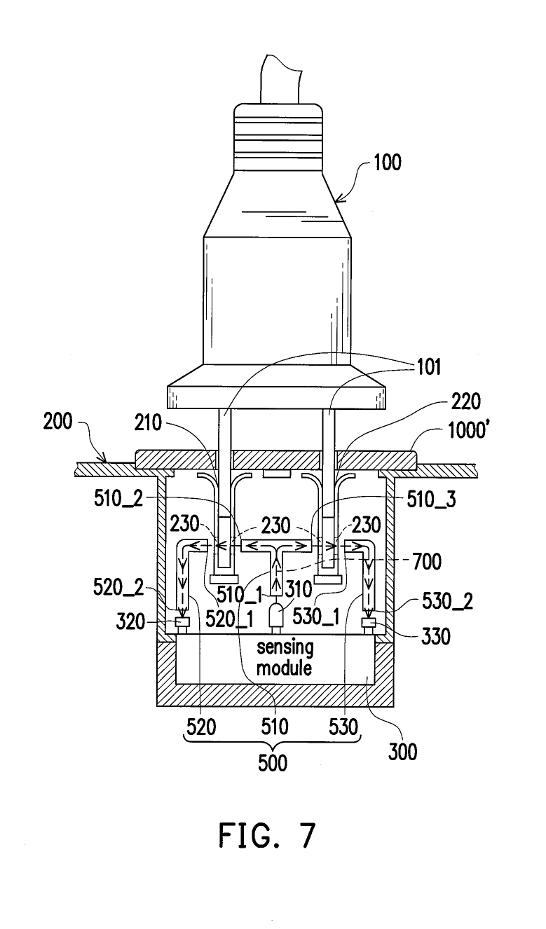

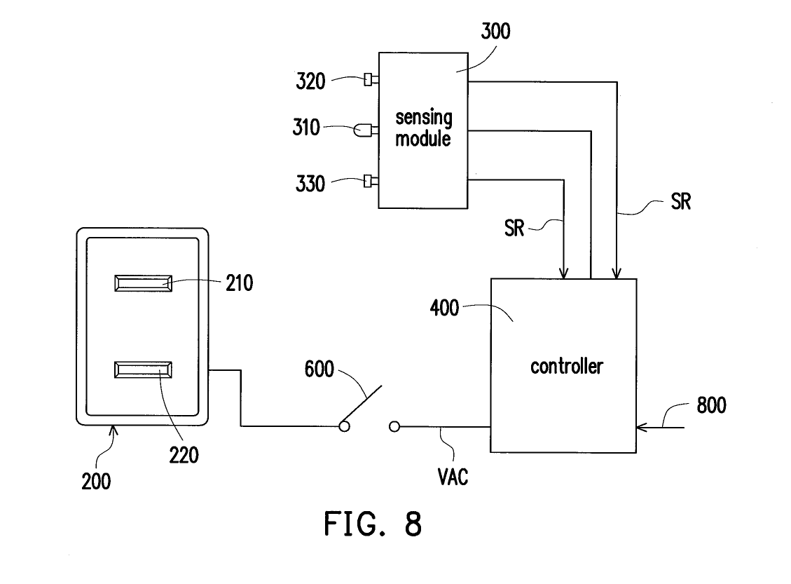

FIG. 7, FIG. 8, and FIG. 4 illustrate a sparkless socket 1000′ according to the second embodiment of the invention. Referring to FIG. 7, FIG. 8, and FIG. 4 hereafter, the sparkless socket 1000′ may provide a configuration to a pair of pins 101 of a plug 100. The sparkless socket 1000′ includes a socket 200, a sensing module 300, a controller 400, and a light guide element module 500. A through hole 230 is configured on a slot wall of each of the first slot 210 and the second slot 220, where the through holes 230 are able to pass through each other.

An emitter 310, a first receiver 320, and a second receiver 330 are configured on the sensing module 300, where the emitter 310 is disposed between the first receiver 320 and the second receiver 330. The emitter 310 is configured to emit infrared light 700 and transmit the infrared light 700 to the first receiver 320 and the second receiver 330 through the light guide element module 500 via the through holes 230.

In the present embodiment, the light guide element module 500 includes a first light guide pillar 510, a second light guide pillar 520, and a third light guide pillar 530. The first light guide pillar 510 has a T-shaped structure and is disposed among the first slot 210, the second slot 220, and the emitter 310. The first light guide pillar 510 is configured to guide the infrared light 700 emitted by the emitter 310. An entrance port 510_1 of the first light guide pillar 510 is facing to the emitter 310 so as to receive the infrared light 700 emitted thereby. An exit port 510_2 of the first light guide pillar 510 is facing to the through hole 230 of the first slot 210, and another exit port 510_3 of the first light guide pillar 510 is facing to the through hole 230 of the second slot 220. The second light guide pillar 520 is disposed between the first slot 210 and the first receiver 320. An entrance port 520_1 of the second light guide pillar 520 is facing to the through hole 230 of the second slot 220, and an exit port 520_2 of the second light guide pillar 520 is facing to the first receiver 320. The third light guide pillar 530 is disposed between the second slot 220 and the second receiver 330. An entrance port 530_1 of the third light guide pillar 530 is facing to the through hole 230 of the second slot 220, and an exit port 530_2 of the third light guide pillar 530 is facing to the second receiver 330.

To be specific, the infrared light 700 emitted by the emitter 310 may be transmitted to the first receiver 320 via the first light guide pillar 510, the through hole 230 of the first slot 210, and the second light guide pillar 520. The first receiver 320 may generate a sensing result SR based on whether the infrared light 700 is received. Also, the infrared light 700 emitted by the emitter 310 may be transmitted to the second receiver 330 via the first light guide pillar 510, the through hole 230 of the second slot 220, and the third light guide pillar 530. The second receiver 330 may generate a sensing result SR based on whether the infrared light 700 is received.

The controller 400, coupled to a city power system 800 and the sensing module 300, is configured to receive the sensing result SR. A switching module 600, coupled between the socket 200 and the controller 400, receives AC power VAC from the city power system 800 and is controlled by the controller 400 to transmit the AC power VAC to the socket 200. The controller 400 would enable or disable the switching module 600 based on the sensing result SR.

Accordingly, referring to FIG. 7, when the pins 101 of the plug 100 are not inserted or are not completely inserted into the first slot 210 and the second slot 220 of the socket 200, the infrared light 700 emitted by the emitter 310 would first pass the T-shaped first light guide pillar 510. After the infrared light 700 enters the first light guide pillar 510, it would be incident in directions towards the first slot 210 and the second slot 220 on both sides. The infrared light 700 incident towards the first slot 210 would pass through the through hole 230 on the slot wall of the first slot 210 and would be transmitted to the first receiver 320 via the second light guide pillar 520. The infrared light 700 incident towards the second slot 220 would pass through the through hole 230 on the slot wall of the second slot 220 and would be transmitted to the second receiver 330 via the third light guide pillar 530. When any one or both of the first receiver 320 and the second receiver 330 sense the infrared light 700, the sensing module 300 would transmit the sensing result SR to the controller 400. Meanwhile, the controller 400 would control the switching module 600 to be disabled so that the AC power VAC of the city power system 800 would not be able to be provided to the socket 200 through the switching module 600.

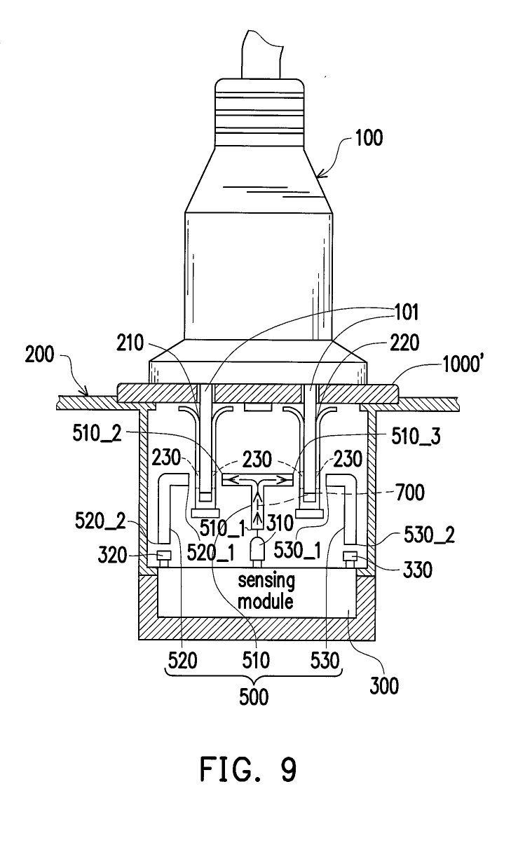

Referring to FIG. 9, after the pins 101 of the plug 100 are completely inserted into the first slot 210 and the second slot 220 of the socket 200, the pins 101 of the plug 100 would cover the through holes 230 both on the slot wall of the first slot 210 and the second slot 220, and thereby block the infrared light 700 transmitted via the first light guide pillar 510. Hence, the infrared light 700 would not be able to arrive at the first receiver 320 and the second receiver 330. Meanwhile, the first receiver 320 and the second receiver 330 may transmit the sensing result SR of “unable to sense the infrared light 700” to the controller 400. The controller 400 may then switch the switching module 600 to be enabled so that the AC power VAC from the city power system 800 would be able to be transmitted to the socket 200 through the switching module 600 and thereby provide load power to the plug 100. By contrast, during power supply operation, once the first receiver 320 or the second receiver 330 senses the infrared light 700, the controller 400 would switch the switching module 600 to be disabled immediately (e.g. within 0.015 s or within 15 ms). Thus, sparks which cause dangers would be prevented from being generated between the pins 101 and each of the first slot 210 and the second slot 220.

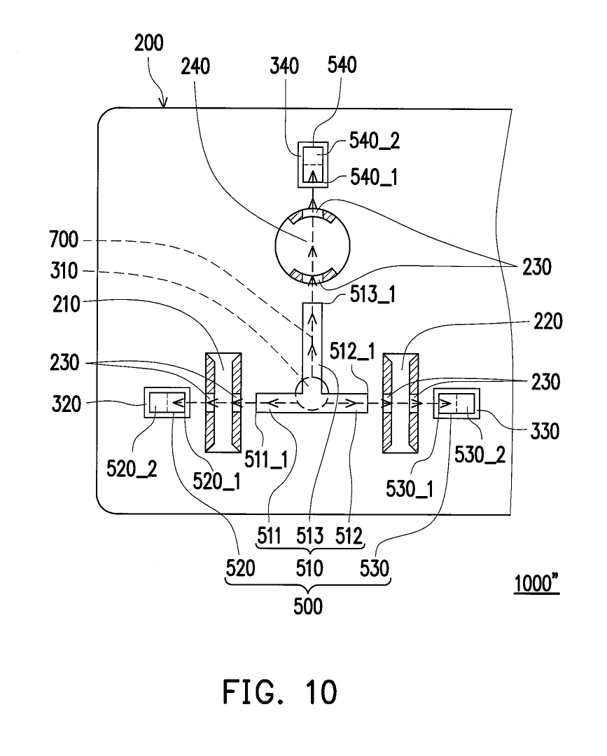

FIGS. 10-13 illustrate a sparkless socket 1000″ according to the third embodiment of the invention. Referring to FIGS. 10-13 hereafter, the sparkless socket 1000″ may provide a configuration to three pins 101 of a plug 100. The sparkless socket 1000″ includes a socket 200, a sensing module 300, a controller 400, and a light guide element module 500. The socket 200 includes a first slot 210, a second slot 220, and a third slot 240 at a different direction from the first slot 210 and the second slot 220. A through hole 230 is configured on a slot wall of each of the first slot 210, the second slot 220, and the third slot 240, where a same light source may pass through the three through holes 230 at the same time.

An emitter 310, a first receiver 320, a second receiver 330, and a third receiver 340 are configured on the sensing module 300. The emitter 310 is configured to emit infrared light 700 and transmit the infrared light 700 to the first receiver 320, the second receiver 330, and the third receiver 340 through the light guide element module 500 via the through holes 230.

In the present embodiment, the light guide element module 500 includes a first light guide pillar 510, a second light guide pillar 520, a third light guide pillar 530, and a fourth light guide pillar 540. The first light guide pillar 510 is disposed among the first slot 210, the second slot 220, the third slot 240, and the emitter 310, and is configured to guide the infrared light 700 emitted by the emitter 310. An entrance port 514_1 of the first light guide pillar 510 is facing to the emitter 310 so as to receive the infrared light 700 emitted thereby. Three exit ports 511_1, 512_1, and 513_1 of the first light guide pillar 510 are respectively facing to the through hole 230 of the first slot 210, the through hole 230 of the second slot 220, and the through hole 230 of the third slot 240.

The second light guide pillar 520 is disposed between the first slot 210 and the first receiver 320. An entrance port 520_1 of the second light guide pillar 520 is facing to the through hole 230 of the first slot 210, and an exit port 520_2 of the second light guide pillar 520 is facing to the first receiver 320. The third light guide pillar 530 is disposed between the second slot 220 and the second receiver 330. An entrance port 530_1 of the third light guide pillar 530 is facing to the through hole 230 of the second slot 220, and an exit port 530_2 of the third light guide pillar 530 is facing to the second receiver 330. The fourth light guide pillar 540 is disposed between the third slot 240 and the third receiver 340. An entrance port 540_1 of the fourth light guide pillar 540 is facing to the through hole 230 of the third slot 240, and an exit port 540_2 of the fourth light guide pillar 540 is facing to the third receiver 340.

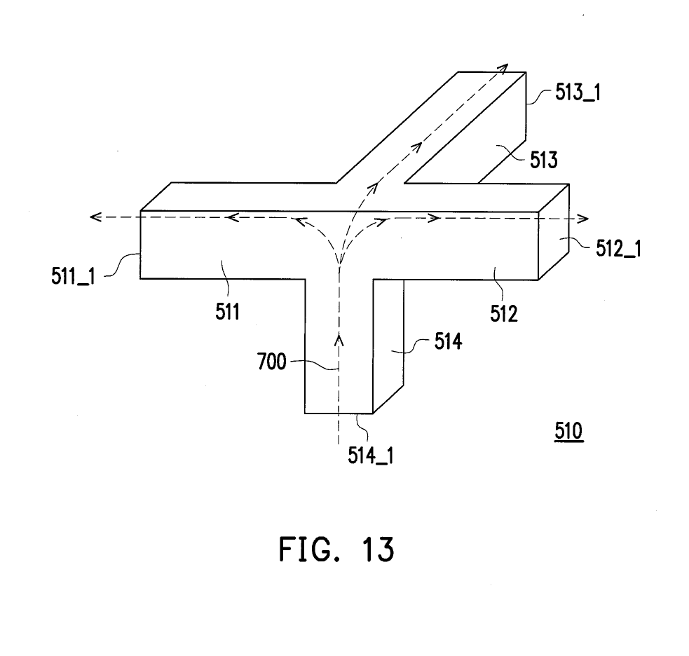

The first light guide pillar 510 includes a first pin 511, a second pin 512, a third pin 513, and a fourth pin 514. As illustrated in FIG. 13, the first pin 511, the second pin 512, the third pin 513, and the fourth pin 514 are connected to each other and form a three-dimensional double T-shaped structure. The first pin 511, the second pin 512, and the third pin 513 are connected to each other and form a T-shaped structure. The first pin 511, the second pin 512, and the fourth pin 514 are connected to each other and form another T-shaped structure. The third pin 513 and the fourth pin 514 are connected and form an inverted L-shaped structure. The entrance port 514_1 of the first light guide pillar 510 is disposed at the fourth pin 514, and the three exit ports 511_1, 512_1, and 513_1 of the first light guide pillar 510 are respectively disposed at the first pin 511, the second pin 512, and the third pin 513.

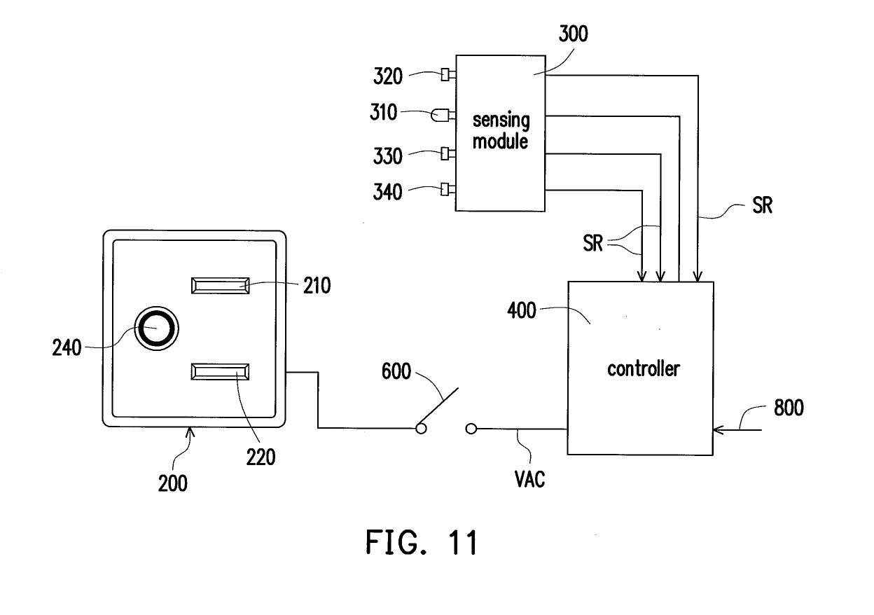

Hence, referring to FIG. 10, FIG. 11, and FIG. 13, when the three pins 101 of the plug 100 are not inserted or are not completely inserted into the first slot 210, the second slot 220, and the third slot 240 of the socket 200, the infrared light 700 emitted by the emitter 310 would first pass by the fourth pin 514 of the first light guide pillar 510. Next, the infrared light 700 passing by the fourth pin 514 would pass through each of the through holes 230 on the slot wall of the first slot 210, the second slot 220, and the third slot 240 via the first pin 511, the second pin 512, and the third pin 513. The infrared light 700 passing through the through hole 230 of the first slot 210 would be transmitted to the first receiver 320 via the second light guide pillar 520. The infrared light 700 passing through the through hole 230 of the second slot 220 would be transmitted to the second receiver 330 via the third light guide pillar 530. The infrared light 700 passing through the through hole 230 of the third slot 240 would be transmitted to the third receiver 340 via the fourth light guide pillar 540. When the first receiver 320, the second receiver 330, and the third receiver 340 sense the infrared light 700, the sensing module 300 would transmit the sensing result SR to the controller 400. Meanwhile, the controller 400 may control the switching module 600 to be disabled so that the AC power VAC of the city power system 800 would not be able to be provided to the socket 200 through the switching module 600.

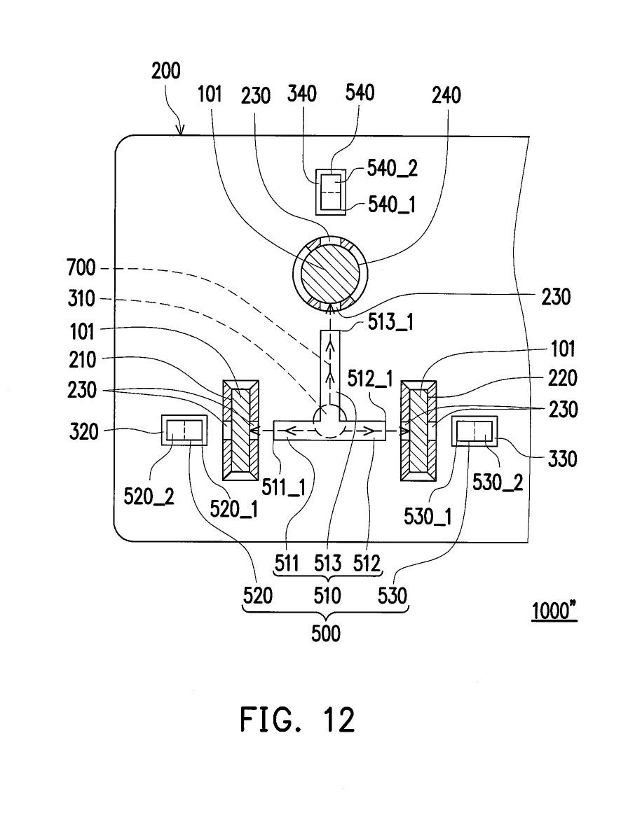

Referring to FIG. 12, after the pins 101 of the plug 100 are completely inserted into the first slot 210, the second slot 220, and the third slot 240 of the socket 200, the pins 101 of the plug 100 would cover the through hole 230 of each of the first slot 210, the second slot 220, and the third slot 240, and thereby block the infrared light 700 guided by the first light guide pillar 510. Hence, the infrared light 700 would not be able to arrive at the first receiver 320, the second receiver 330, and the third receiver 340. Meanwhile, the first receiver 320, the second receiver 330, and the third receiver 340 may transmit the sensing result SR of “unable to sense the infrared light 700” to the controller 400. The controller 400 may then switch the switching module 600 to be enabled so that the AC power VAC from the city power system 800 would be able to be transmitted to the socket 200 through the switching module 600 and thereby provide load power to the plug 100. By contrast, during power supply operation, once any of the first receiver 320, the second receiver 330, and the third receiver senses the infrared light 700, the controller 400 would switch the switching module 600 to be disabled immediately (e.g. within 0.015 s or within 15 ms). It should be noted that, the third slot 240 is often for ground use, and thus it is sometimes not in use. In such instance, extra software or hardware options may be provided for assistances. For example, a software option may be used for setting so as to allow the controller 400 to neglect the sensing result SR from the third receiver when determining whether the pins 101 of the plug 100 are completely inserted into the first slot 210, the second slot 220, and the third slot 240.

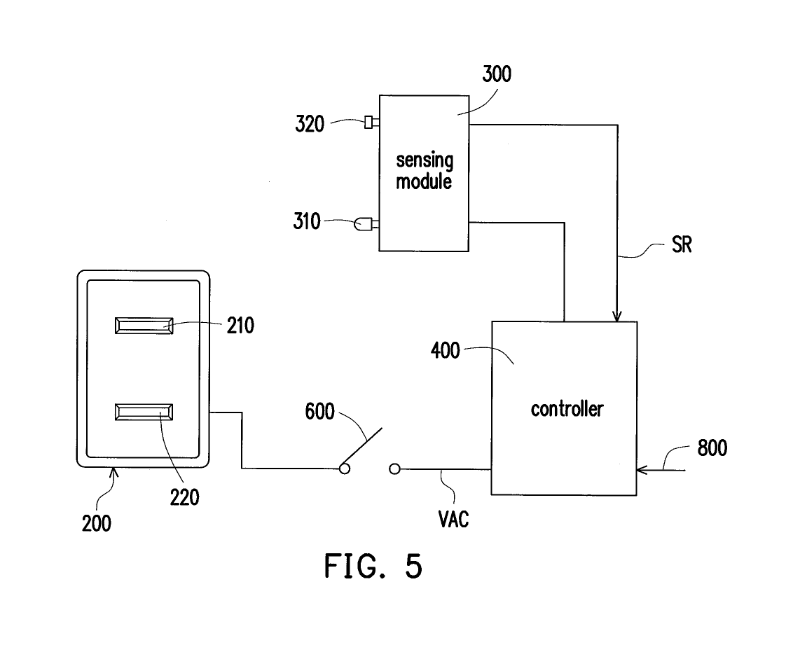

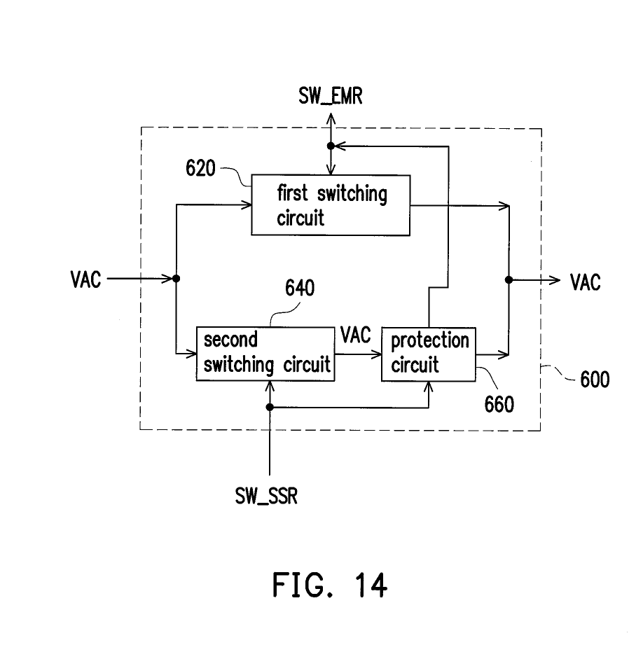

The switching module 600 in the aforesaid embodiments will be described hereafter. FIG. 14 is a circuit block schematic diagram of the switching module 600 as illustrated in FIG. 5, FIG. 8, and FIG. 11. Referring to FIG. 5, FIG. 8, FIG. 11, and FIG. 14, the switching module 600 includes a first switching circuit 620, a second switching circuit 640, and a protection circuit 660. In an embodiment of the invention, the first switching circuit 620 may include an electromagnetic relay, and the second switching circuit 640 may include a solid state relay, and yet the invention is not limited thereto. In other embodiments of the invention, the first switching circuit 620 may be, for example, a switching circuit which is capable of carrying a higher current load and is less affected by temperature changes, and the second switching circuit 640 may be, for example, a switching circuit with less power consumption and high switching speed.

The first switching circuit 620 is coupled between the controller 400 and the socket 200 so as to receive the AC power VAC from the city power system 800 through the controller 400. The first switching circuit 620 is controlled by a first control signal SW_EMR to transmit the AC power VAC to the socket 200, where the first control signal SW_EMR may be generated by the controller 400 or the protection circuit 600. In other words, the first switching circuit 620 may be controlled by the controller 400 or the protection circuit 600 based on the load of the socket 200. More details will be described later on.

The second switching circuit 640 is coupled to the controller 400 so as to receive the AC power VAC from the city power system 800. The protection circuit 660 is coupled between the second switching circuit 640 and the socket 200. As illustrated in FIG. 14, the second switching circuit 640 and the protection circuit 660 are serially connected, and the second switching circuit 640 and the protection circuit 660 are parallel connected to the first switching circuit 620. The second switching circuit 640 is controlled by a second control signal SW_SSR to transmit the AC power VAC to the socket 200 via the protection circuit 660. The protection circuit 660 is controlled by the second control signal SW_SSR to examine the load power of the socket 200 when the second switching circuit 640 is on, where the second control signal SW_SSR is generated by the controller 400. In other words, the controller 400 may concurrently control to turn on or turn off the second switching circuit 640 and the protection circuit 660 based on the second control signal SW_SSR.

It is understood that the switching module 600 includes two power transmission channels. One of the power transmission channels receives the AC power VAC from the controller 400 via the first switching circuit 620 and transmits the AC power VAC to the socket 200. The other one of the power transmission channels receives the AC power VAC from the controller 400 via the second switching circuit 640 and the protection circuit 660 and transmits the AC power VAC to the socket 200. That is, the enablement or the disablement of the switching module 600 may be set by controlling the on or off of the first switching module 620 and the second switching module 640.

The operation of the switching module 600 will be described in terms of the first embodiment as illustrated in FIG. 3-FIG. 6. The operation of the switching module 600 in other embodiments may be deduced according to the following description. Referring to FIGS. 3-6 and FIG. 14, when the pins 101 of the plug 100 of an appliance (not shown) are not inserted or are not completely inserted into the first slot 210 and the second slot 220 of the socket 200, the first receiver 320 would sense the infrared light 700. Meanwhile, the controller 400 would generate the first control signal SW_EMR and the second control signal SW_SSR to control the first switching circuit 620 and the second switching circuit 640 to be off so that the AC power VAC from the city power system 800 may not be able to be provided to the socket 200 through the switching module 600.

After the pins 101 of the plug 100 of the appliance are completely inserted into the first slot 210 and the second slot 220 of the socket 200, the first receiver 320 would transmit the sensing result SR of “unable to sense the infrared light 700” to the controller 400. The controller 400 may then switch the first switching circuit 620 or the second switching circuit 640 in the switching module 600 to be on so that the AC power VAC from the city power system 800 would be able to be transmitted to the socket 200 through one of the power transmission channels of the switching module 600 and thereby provide load power to the plug 100 (i.e. the appliance).

Furthermore, the controller 400 may also determine the power requirement of the appliance on the socket 200 and the load power of the appliance. The controller 400 may switch the first switching circuit 620 and the second switching circuit 640 of the switching module 600 based on the determined load power of the socket 200.

In general, when the electromagnetic relay of the first switching circuit 620 is under-loaded, its power consumption is relatively higher than that of the solid state relay of the second switching circuit 640. The electromagnetic relay of the first switching circuit 620 would even continue consuming power while it is standing by (i.e. not loaded). On the other hand, the power consumption of the solid state relay of the second switching circuit 640 is proportional to the load current. Hence, while the solid state relay is standing by (i.e. not loaded, the load current is approximately 0 A) or under-loaded (e.g. the load current is less than 0.5 A), it possesses a characteristics of zero power consumption or low power consumption and thus is able to effectively reduce electricity consumption with higher switching speed.

Under the aforesaid condition, when the load power of the socket 200 is less than a power-saving threshold TH2, the controller 400 would turn on the second switching circuit 640 and the protection circuit 660 as well as turn off the first switching circuit 620 so as to make the sparkless socket 1000 operate in a low power mode. Conversely, when the load power of the socket 200 is continuously greater than the power-saving threshold TH2 for a pre-setting time duration, the controller 400 would turn on the first switching circuit 620 as well as turn off the second switching circuit 640 and protection circuit 660 so as to make the sparkless socket 1000 operate in a high power mode. The aforesaid power-saving threshold TH2 may be set according to actual applications or design requirements.

In general, after the user finishes using the appliance, he/she would often turn off the appliance without unplugging the plug 100 of the appliance from the socket 200. Since the pins 101 of the plug 100 are still completely inserted in the first slot 210 and the second slot 220 of the socket 200, the infrared light 700 guided by the first light guide pillar 510 would not arrive at the first receiver 320. Hence, the controller 400 would keep the switching module 600 enabled. In other words, the AC power VAC from the city power system 800 would be continuously provided to the socket 200. Meanwhile, since the switch of the appliance inserted in the socket 200 (i.e. on load) is off, the load power of the socket 200 examined by the controller 400 is 0 W. After the controller 400 determines that the load power of the socket 200 is continuously less than the power-saving threshold TH2 for a predetermined time period, the controller 400 would turn on the second switching circuit 640 and the protection circuit 660 as well as turn off the first switching circuit 620 so as to make the sparkless socket 1000 operate in a low power mode.

Under such condition, if the appliance inserted in the socket 200 is a high power appliance (e.g. air conditioner, oven, or hair dryer), when the user turns on the appliance, an extreme current would instantaneously flow from the city power system 800, via the controller 400 and the switching module 600, and to the appliance coupled to the socket 200. Since the sparkless socket 1000 operates under the low power mode (i.e. the second switching circuit 640 is on and the first switching circuit 620 is off), if the extreme current exceeds a rated current of the solid state relay of the second switching circuit 640 (i.e. the second switching circuit 640 is over-loaded), the solid state relay of the second switching circuit 640 may be possibly damaged. Besides, when the second switching circuit 640 is over-loaded, the controller 400 mostly may not be able to switch the switching module 600 instantly (e.g. within milliseconds), and thus the risk of damaging the solid state relay of the second switching circuit 640 may be greatly increased. To avoid such scenario, the protection circuit 660 may perform overload protection on the second switching circuit 640.

To be specific, when the protection circuit 660 determines that the load power of the socket 220 is greater than an overload threshold TH1, it may generate the first control signal SW_EMR instantly (e.g. in milliseconds) to turn on the first switching circuit 620. Since the second switching circuit 640 is parallel connected to the first switching circuit 620 and the first switching circuit 620 is capable of carrying a higher current load, the first switching circuit 620 may divide overload currents when the second switching circuit 640 is over-loaded (i.e. the overload power is greater than the overload threshold TH1) so as to perform overload protection on the second switching circuit 640. The aforesaid overload threshold TH1 may be set according to actual applications or design requirements, where the power-saving threshold TH2 is normally less than the overload threshold TH1.

Moreover, the protection circuit 660 may provide notification for the controller 400 through the first control signal SW_EMR. When the controller 400 determines that the first switching circuit 620 is turned on by the protection circuit 660 according to the first control signal SW_EMR, the controller 400 would generate the second control signal SW_SSR to turn off the second switching circuit 640 and the protection circuit 660 as well as control the switching circuit 620 to remain being on. Regarding the detailed implementation of the first switching circuit 620, the second switching circuit 640, and the protection circuit 660 may refer to U.S. patent application Ser. No. 14/640,024, titled “POWER TRANSMISSION APPARATUS WITH OVER-LOADING PROTECTION AND POWER-SAVING MECHANISM”.

In summary, the sparkless socket provided in the embodiments of the invention allows the controller to disable the switching module based on infrared light emitted by the emitter and received by the receiver via the through holes before a plug of an appliance is completely plugged into the socket. On the other hand, after the plug of the appliance is completed plugged into the socket, the through holes would be covered by the plug so that the infrared light emitted by the emitter would be blocked and would not be transmitted to the receiver. Meanwhile, the controller, which has not received any infrared sensing signal, would switch the switching module to be enabled so as to provide AC power to the socket. Thus, sparks would be prevented from being generated at the moment when pins of a plug are contacted with or pulled out from the socket so as to enhance the electricity safety.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A sparkless socket, adapted to provide a configuration to a pair of pins of a plug, comprising:
a socket, comprising a first slot and a second slot therein, wherein a through hole is configured on a slot wall of each of the first slot and the second slot, and wherein the through holes pass through each other;
a sensing module, comprising:
an emitter, configured to emit infrared light; and
a first receiver, configured to receive the infrared light via a light guide element module and at least one of the through holes and accordingly generate a first sensing result;
a controller, coupled to the sensing module, configured to receive the first sensing result, and connected to a city power system; and
a switching module, coupled between the socket and the controller to receive alternating-current (AC) power provided by the city power system from the controller, and controlled by the controller to transmit the AC power to the socket,
wherein when the controller determines that the first receiver does not receive the infrared light based on the first sensing result, the controller enables the switching module, and otherwise, the controller disables the switching module.

2. The sparkless socket according to claim 1, wherein the sensing module further comprises:
a second receiver, configured to receive the infrared light via the light guide element module and one of the through holes and accordingly generate a second sensing result,
wherein the first receiver is configured to receive the infrared light via the light guide element module and another one of the through holes and accordingly generate the first sensing result, and
wherein when the controller determines that none of the first receiver and the second receiver receives the infrared light according to the first sensing result and the second sensing result, the controller enables the switching module, and otherwise, the controller disables the switching module.

3. The sparkless socket according to claim 2, wherein the emitter is disposed between the first receiver and the second receiver, and wherein the light guide element module comprises:
a first light guide pillar, disposed among the first slot, the second slot, and the emitter, and configured to guide the infrared light emitted by the emitter, wherein an entrance of the first light guide pillar is facing to the emitter to receive the infrared light emitted by the emitter, wherein an exit of the first light guide pillar is facing to the through hole of the first slot, and wherein another exit of the first light guide pillar is facing to the through hole of the second slot;
a second light guide pillar, disposed between the first slot and the first receiver, wherein an entrance of the second light guide pillar is facing to the through hole of the first slot, and wherein an exit of the second light guide pillar is facing to the first receiver; and
a third light guide pillar, disposed between the second slot and the second receiver, wherein an entrance of the third light guide pillar is facing to the through hole of the second slot, and wherein an exit of the third light guide pillar is facing to the second receiver.

4. The sparkless socket according to claim 3,
wherein when the pair of pins of the plug is not inserted or not completely inserted into the first slot and the second slot, the infrared light emitted by the emitter is transmitted to the first receiver via the first light guide pillar, the through hole of the first slot, and the second light guide pillar sequentially, and wherein the infrared light emitted by the emitter is transmitted to the second receiver via the first light guide pillar, the through hole of the second slot, and the third light guide pillar sequentially; and
wherein after the pair of pins of the plug is completely inserted into the first slot and the second slot, the pair of pins of the plug covers the through hole of the first slot and the through hole of the second slot to block the infrared light guided by the first light guide pillar.

5. The sparkless socket according to claim 1, wherein the light guide element module comprises:
a first light guide pillar, disposed between the first slot and the emitter, and configured to guide the infrared light emitted by the emitter, wherein an entrance of the first light guide pillar is facing to the emitter to receive the infrared light emitted by the emitter, and wherein an exit of the first light guide pillar is facing to the through hole of the first slot; and
a second light guide pillar, disposed between the second slot and the first receiver, wherein an entrance of the second light guide pillar is facing to the through hole of the second slot, and wherein an exit of the second light guide pillar is facing to the first receiver,
wherein the first slot and the second slot are disposed between the first light guide pillar and the second light guide pillar.

6. The sparkless socket according to claim 5,
wherein when the pair of pins of the plug is not inserted or not completely inserted into the first slot and the second slot, the infrared light emitted by the emitter is transmitted to the first receiver via the first light guide pillar, the through hole of the first slot, the through hole of the second slot, and the second light guide pillar sequentially; and
wherein after the pair of pins of the plug is completely inserted into the first slot and the second slot, the pair of pins of the plug covers the through hole of the first slot and the through hole of the second slot to block the infrared light guided by the first light guide pillar.

7. The sparkless socket according to claim 1, wherein the switching module comprises:
a first switching circuit, coupled between the controller and the socket to receive the AC power from the controller, and controlled by a first control signal to transmit the AC power to the socket;
a second switching circuit, coupled to the controller to receive the AC power; and
a protection circuit, coupled between the second switching circuit and the socket,
wherein the second switching circuit is controlled by a second control signal and transmits the AC power to the socket through the protection circuit,
wherein the protection circuit is controlled by the second control signal to detect load power of the socket while the second switching circuit is on, wherein when an instantaneous variation of the load power is greater than an overload threshold, the protection circuit generates the first control signal to turn on the first switching circuit so as to protect the second switching circuit which is on,
wherein the controller receives the first control signal, and wherein when the controller determines that the first switching circuit is turned on according to the first control signal, the controller controls the first switching circuit to remain being on, and the controller generates the second control signal to turn off the second switching circuit and the protection circuit.

8. A sparkless socket, adapted to provide a configuration to three pins of a plug, comprising:
a socket, comprising a first slot, a second slot, and a third slot at a different direction from the first slot and the second slot, wherein a through hole is configured on a slot wall of each of the first slot, the second slot, and the third slot;
a sensing module, comprising:
an emitter, configured to emit infrared light;
a first receiver, configured to receive the infrared light via a light guide element module and the through hole of the first slot and accordingly generate a first sensing result;
a second receiver, configured to receive the infrared light via the light guide element module and the through hole of the second slot and accordingly generate a second sensing result; and
a third receiver, configured to receive the infrared light via the light guide element module and the through hole of the third slot and accordingly generate a third sensing result;
a controller, coupled to the sensing module, configured to receive the first sensing result, the second sensing result, and the third sensing result, and connected to a city power system; and
a switching module, coupled between the socket and the controller to receive alternating-current (AC) power provided by the city power system from the controller, and controlled by the controller to transmit the AC power to the socket,
wherein when the controller determines that none of the first receiver, the second receiver, and the third receiver receives the infrared light based on the first sensing result, the second sensing result, and the third sensing result, the controller enables the switching module, and otherwise, the controller disables the switching module.

9. The sparkless socket according to claim 8, wherein the light guide element module comprises:
a first light guide pillar, disposed among the first slot, the second slot, the third slot, and the emitter, and configured to guide the infrared light emitted by the emitter, wherein an entrance of the first light guide pillar is facing to the emitter to receive the infrared light emitted by the emitter, and wherein three exits of the first light guide pillar are respectively facing to the through hole of the first slot, the through hole of the second slot, and the through hole of the third slot;
a second light guide pillar, disposed between the first slot and the first receiver, wherein an entrance of the second light guide pillar is facing to the through hole of the first slot, and wherein an exit of the second light guide pillar is facing to the first receiver;
a third light guide pillar, disposed between the second slot and the second receiver, wherein an entrance of the third light guide pillar is facing to the through hole of the second slot, and wherein an exit of the third light guide pillar is facing to the second receiver; and
a fourth light guide pillar, disposed between the third slot and the third receiver, wherein an entrance of the fourth light guide pillar is facing to the through hole of the third slot, and wherein an exit of the fourth light guide pillar is facing to the third receiver.

10. The sparkless socket according to claim 9,
wherein the first light guide pillar comprises a first pin, a second pin, a third pin, and a fourth pin, and wherein the first pin, the second pin, the third pin, and the fourth pin form a three-dimensional double T-shaped structure,
wherein the first pin, the second pin, and the third pin are connected to each other and form a T-shaped structure, wherein the first pin, the second pin, and the fourth pin are connected to each other and form a T-shaped structure, and wherein the third pin and the fourth pin are connected and form an inverted-L structure, and
wherein the entrance of the first light guide pillar is disposed at the fourth pin, and wherein the three exits of the first light guide pillar are respectively disposed at the first pin, the second pin, and the third pin.

11. The sparkless socket according to claim 9,
wherein when the three pins of the plug are not inserted or not completely inserted into the first slot, the second slot, and the third slot, the infrared light emitted by the emitter is transmitted to the first receiver via the first light guide pillar, the through hole of the first slot, and the second light guide pillar sequentially, wherein the infrared light emitted by the emitter is transmitted to the second receiver via the first light guide pillar, the through hole of the second slot, and the third light guide pillar sequentially; and wherein the infrared light emitted by the emitter is transmitted to the third receiver via the first light guide pillar, the through hole of the third slot, and the fourth light guide pillar sequentially; and
wherein after the three pins of the plug are completely inserted into the first slot, the second slot, and the third slot, the three pins of the plug cover the through hole of the first slot, the through hole of the second slot, and the through hole of the third slot to block the infrared light guided by the first light guide pillar.

12. The sparkless socket according to claim 8, wherein the switching module comprises:
a first switching circuit, coupled between the controller and the socket to receive the AC power from the controller, and controlled by a first control signal to transmit the AC power to the socket;
a second switching circuit, coupled to the controller to receive the AC power; and
a protection circuit, coupled between the second switching circuit and the socket,
wherein the second switching circuit is controlled by a second control signal and transmits the AC power to the socket through the protection circuit,
wherein the protection circuit is controlled by the second control signal to detect load power of the socket while the second switching circuit is on, wherein when an instantaneous variation of the load power is greater than an overload threshold, the protection circuit generates the first control signal to turn on the first switching circuit so as to protect the second switching circuit which is on,
wherein the controller receives the first control signal, and wherein when the controller determines that the first switching circuit is turned on according to the first control signal, the controller controls the first switching circuit to remain being on, and the controller generates the second control signal to turn off the second switching circuit and the protection circuit.
